(19) United States
(12) Patent Application Publication
(10) Pub. No.: US 2014/0299579 A1
(43) Pub. Date: Oct. 9, 2014

(54) DC VOLTAGE CIRCUIT BREAKER

(71) Applicants: Werner Hartmann, Weisendorf (DE); Sylvio Kosse, Erlangen (DE); Frank Schettler, Erlangen (DE)

(72) Inventors: Werner Hartmann, Weisendorf (DE); Sylvio Kosse, Erlangen (DE); Frank Schettler, Erlangen (DE)

(73) Assignee: SIEMENS AKTIENGESELLSCHAFT, MUENCHEN (DE)

(21) Appl. No.: 14/347,718

(22) PCT Filed: Aug. 30, 2012
(86) PCT No.: PCT/EP2012/066885

§ 371 Date: Mar. 27, 2014

(30) Foreign Application Priority Data
Sep. 27, 2011 (DE) 10 2011 083 514.8

(51) Int. Cl. H01H 3/02; H02H 3/087; H02H 3/02

(52) U.S. Cl. CPC H01H 3/0213; H02H 3/021; H02H 3/087; H01H 2033/146
USPC 218/145; 361/93.1

(57) ABSTRACT

A DC voltage circuit breaker includes at least one interrupter and a commutator device connected in parallel with the interrupter. The commutator device includes a capacitor circuit. The capacitor circuit includes a parallel circuit having at least two capacitor branches and the capacitor branches each have a capacitor in series with a capacitor branch switch.

The present invention relates to a DC voltage circuit breaker.

Electric energy is generally generated in power plants as three-phase alternating current. For transmission, this energy is transformed to very high electric AC voltages by power transformers and transmitted via overhead lines. However, in very long overhead lines, transmission of the energy using direct current is associated with lower losses and is therefore more advantageous.

However, in the related art, there are problems with direct-current transmission in controlling power flows in mesh line networks. Therefore, for direct-current transmission, point-to-point connections without branches or meshes have been used almost exclusively up to now. However, construction and expansion of direct-current line networks is planned for the future. For this purpose, DC voltage circuit breakers are required in order to increase the availability of the planned direct-current line networks. DC voltage circuit breakers are used to selectively disconnect portions of a line network in the event of an incident, thereby preventing a failure of the entire line network.

For this purpose, for disconnecting a direct current in the DC voltage circuit breaker, it is known to generate a reverse current, which results in a current zero-crossing. To this end, a capacitor is discharged. It is disadvantageous that the current pulse that is impressed onto the lines connected to the switch via the disconnection process may be interpreted as a fault at points on the network that are distant from the switch and thus may trigger additional undesired switching operations. In addition, the capacitor used for the current zero-crossing must be designed for the disadvantageous operating case of a short circuit. However, the capacitor is substantially oversized for disconnecting substantially lower operating currents and overload currents, which, in addition to erroneous interpretations in the network, may even result in switching failures.

The object of the present invention is to provide an improved DC voltage circuit breaker. An additional object is to specify a method for operating such a DC voltage circuit breaker. These objects are achieved with respect to the circuit breaker through a DC voltage circuit breaker having the features in claim 1. With respect to the method, an approach exists in the method having the features in claim 9.

The DC voltage circuit breaker according to the present invention has at least one interrupter and one commutator device situated in parallel with the interrupter. The commutator device comprises a capacitor circuit which, for its part, comprises a parallel connection of at least two capacitor branches. The capacitor branches each have a capacitor in series with an inductor and a capacitor branch switch.

With the DC voltage circuit breaker according to the present invention, it is advantageously possible to vary the level of the generated reverse current. By closing various combinations of capacitor branch switches, reverse currents of various magnitudes may be generated. Thus, the enforcement of the current zero-crossing in the interrupter may be adjusted to the present situation, and the risk of generating 2011P20194W0US the appearance of a fault at another point in the network is reduced. Thus, load currents and overload currents in the network may be disconnected with minimal impact on or loading of the network.

The commutator device advantageously comprises a series connection of a commutator resistor, a commutator coil, and the capacitor circuit. It is also advantageous if an energy absorber is provided in a parallel connection to the commutator device for dissipating the energy of the switching process.

It is highly advantageous if the capacitors of the capacitor branches have capacitances that are different from each other. This makes possible a wide-ranging adjustment of the reverse current to the requirements of the disconnection.

In one advantageous refinement of the present invention, one or multiple capacitors are designed in such a way that the producible reverse current is sufficient for switching nominal currents by closing the respective capacitor branch switch(es).

In another advantageous refinement of the present invention, one or multiple capacitors are designed in such a way that the producible reverse current is sufficient for switching short-circuit currents by closing the respective capacitor branch switch(es).

In one advantageous refinement of the present invention, one or multiple capacitors are designed in such a way that the producible reverse current is configured by closing the respective capacitor branch switch(es) for disconnecting the line when currents are very small. In one advantageous embodiment of the present invention, the DC voltage circuit breaker comprises six capacitor branches, of which two capacitor branches are each designed for switching nominal currents, switching short-circuit currents, and disconnecting the line when currents are very small.

The capacitances of the capacitors are preferably in the range from 1 pF to 50 μF.

The method according to the present invention for operating one of the described DC voltage circuit breakers comprises the following steps:

- ascertaining an opening condition for the DC voltage circuit breaker, wherein the opening condition comprises at least one of the following opening conditions:

-- request for disconnecting capacitive loads and lines or cables;

-- request for opening under current flow;

-- increase of the current as an indicator of a short circuit;

-- exceeding a critical current increase rate in the network as an indicator of a short circuit;

- ascertaining at least one capacitor branch that is suitable for the opening condition;

- opening the at least one interrupter unit before triggering the capacitor branch switch; 2011P20194W0US - closing the capacitor branch switch(es) of the ascertained capacitor branches.

When the current zero-crossing occurs, opening of the first interrupter advantageously takes place.

The above-described characteristics, features, and advantages of this invention, as well as the manner in which they are achieved, will be understood more clearly and explicitly in connection with the following description of the exemplary embodiments, which are described in greater detail in connection with the single figure in the drawing:

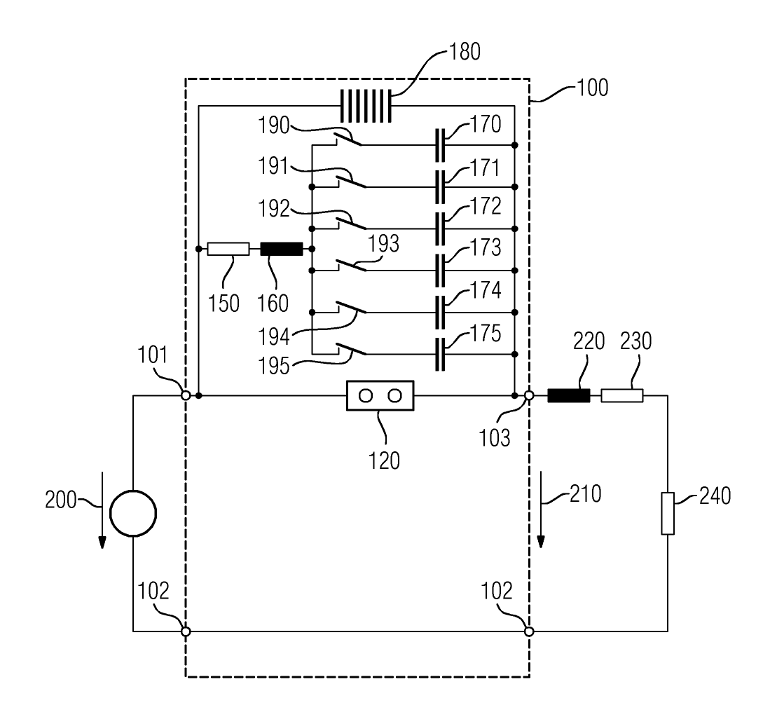

FIG. 1 shows a circuit arrangement of a DC voltage circuit breaker 100. The DC voltage circuit breaker may be integrated into a direct-current line network in order to selectively disconnect a portion of the direct-current line network in the event of a short circuit. The DC voltage circuit breaker 100 may, for example, be provided for use in a high-voltage direct-current line network. In a direct-current line network, the DC voltage circuit breaker 100 enables protection of the positive phase from ground potential, of the negative phase from ground potential, and of the positive phase from the negative phase.

The DC voltage circuit breaker 100 has a first through third node 101 . . . 103. The nodes 101 . . . 103 are circuit nodes of the DC voltage circuit breaker 100, which are each at an electric potential. Thus, the nodes 101 . . . 103 may each also comprise electric line sections if the electric resistances of these line sections are negligible.

A DC voltage 200 may be applied between the first node 101 and the second node 102 of the DC voltage circuit breaker 100. The DC voltage 200 may be a source voltage that is applied by a high-voltage rectifier to a direct-current line network. In this case, the first node 101 and the second node 102 form an input side of the DC voltage circuit breaker 100 and the direct-current line network connecting to the DC voltage circuit breaker 100. The DC voltage 200 applied between the first node 101 and the second node 102 may, for example, be 500 kV. However, the DC voltage 200 may also assume higher voltage values of more than 1200 kV or lower values of only 50 kV. The DC voltage 200 may induce a direct current of 20 kA or more in the direct-current line network in which the DC voltage circuit breaker 100 is used.

An output voltage 210 may be tapped between the third node 103 and the second node 102 of the DC voltage circuit breaker 100. The output voltage 210 is a DC voltage and essentially corresponds to the DC voltage 200 applied between the first node 101 and the second node 102. However, in the event of a short circuit, the DC voltage circuit breaker 100 may break the connection between the first node 101 and the third node 103, so that the output voltage 210 no longer corresponds to the DC voltage 200.

Line portions of the direct-current line network may connect at the third node 103 and the second node 102 by using the DC voltage circuit breaker 100. These portions of the direct-current line network are schematically depicted in FIG. 1 by line impedance 220, a line resistance 230, and a load resistance 240.

An interrupter 120 is situated between the first node 101 and the third node 103. In the event of a short circuit, the interrupter 120 serves to break an electric connection between the first node 101 and the third node 103.

The interrupter 120 is able to break the electric connection between the first node 101 and the third node 103 only if an electric current flowing between the first node 101 and the third node 103 is small, thus approaching the value zero, and the prospective current through the interrupter advantageously changes its sign, i.e., experiences a zero-crossing. Otherwise, the non-extinguishable formation of arcs occurs during the breaking of the connection between the first node 101 and the third node 103, which may damage or destroy the interrupter 120 and the entire DC voltage circuit breaker 100 or other portions of a direct-current line network. Thus, in the event of a short circuit, the electric current flowing between the first node 101 and the third node 103 must be lowered to zero within an extremely short time in order for the interrupter 120 to be able to interrupt the electrical connection between the first node 101 and the third node 103. For this purpose, the DC voltage circuit breaker 100 has a commutator circuit that is situated in parallel with the interrupter 120 between the first node 101 and the third node 103. The commutator circuit of the DC voltage circuit breaker 100 comprises a commutator resistor 150, a commutator coil 160, and a capacitor circuit. The commutator resistor 150, the commutator coil 160, and the capacitor circuit form a series circuit. It is also possible to change the order of the commutator resistor 150, the commutator coil 160, and the capacitor circuit.

The commutator circuit serves to generate a reverse electric current through the interrupter 120 that is directed opposite to the normal current flow and compensates for it. Thus, the commutator circuit causes a zero crossing of the current flow through the interrupter 120, which enables the interrupter 120 to interrupt the electric connection between the first node 101 and the third node 103.

Furthermore, the DC voltage circuit breaker 100 has an energy absorber 180 that is situated between the first node 101 and the third node 103. The energy absorber 180 is therefore connected in parallel with the commutator circuit. The energy absorber 180 serves to absorb the magnetically stored energy that is released in the event of a short circuit and an interruption caused by the DC voltage circuit breaker 100. The energy absorber 180 may, for example, comprise a metal oxide voltage limiter, for example, a ZnO varistor stack.

The capacitor circuit comprises a parallel connection of at least two, preferably three to six capacitor branches. The capacitor branches each comprise a series connection made up of a capacitor branch switch 190 . . . 195 and a capacitor 170 . . . 175. The capacitors are designed to have different capacitances and are charged to a voltage with the aid of a voltage source, which is not specified in greater detail. The capacitance results from the reverse current that is to be generated:

$${L}_{Com} = \frac{{U}_{{C}_{Com}}}{\frac{d i ( t )}{d t}}$$

$$and$$

$${C}_{Com} = \frac{{I}_{Com}}{{U}_{Com}} {L}_{Com}$$

The DC voltage 200 may, for example, be 500 kV. A current flowing into the DC voltage circuit breaker 100 at the first node 101 of the DC voltage circuit breaker 100 may, for example, have amperage of 20 kA.

In the normal operation of the DC voltage circuit breaker 100, the capacitor branch switches 190 . . . 195 of the DC voltage circuit breaker 100 are open. Current flow between the first node 101 and the third node 103 is possible via the interrupter 120. If a short circuit occurs in the direct-current line network in which the DC voltage circuit breaker 100 is used, the electric current flowing through the DC voltage circuit breaker 100 increases sharply. This is detected via a detection device that is not depicted in FIG. 1. If an excessive rise of the electric current flowing in the DC voltage circuit breaker 100 is detected, a disconnection is carried out. For this purpose, the first and/or second capacitor branch switch 190, 191 is/are closed. A reverse current is thus generated, which causes the current through the interrupter 120 to go to zero within a few ms. As a result, the interrupter 120 may disconnect the current permanently. The currents to be disconnected here, i.e., the level of the reverse current, is 50 kA and higher.

An additional situation in which the DC voltage circuit breaker 100 may carry out a disconnection is the desired disconnection when there is a nominal current. In this case, the third and/or fourth capacitor branch switch 192, 193 is/are closed in the DC voltage circuit breaker 100. The connection of one or both capacitors depends on the level of the current to be disconnected. This current may, for example, be between 1 kA and 10 kA. Thus, the DC voltage circuit breaker 100 is able to react flexibly and to allow the reverse current to be lower when the current flow is currently low.

A third situation results if small currents of less than 1 kA are to be disconnected, i.e., a disconnection or switching of lines or small capacitive loads is to be carried out. In this case, the fifth and/or sixth capacitor branch switch 194, 195 are closed. Here, the generated reverse current is comparatively small. Thus, the detectable current pulse outside the DC voltage circuit breaker 100 is also minimized and the probability is reduced that other switches will erroneously detect this current pulse as a short circuit.

The DC voltage circuit breaker 100 enables a physical disconnection in a direct-current line network at energies of up to 20 MJ in a period on the order of 10 ms. This corresponds to the usual level in AC voltage line networks. The DC voltage circuit breaker 100 allows the use of direct-current line networks having meshes, i.e., direct-current line networks that do not comprise just a point-to-point connection. The DC voltage circuit breaker 100 is especially advantageous for use in multi-terminal off-shore high-voltage feed-in points that use renewable energy sources. The DC voltage circuit breaker 100 may, for example, be used in combination with wind turbines. The option of adjusting the reverse current to the present situation using the described circuit breaker minimizes the effect on other parts of the DC voltage network.

1-9. (canceled)

10. A DC voltage circuit breaker, comprising:
at least one interrupter; and
a commutator device connected in parallel with said at least one interrupter;
said commutator device having a capacitor circuit;
said capacitor circuit including a parallel connection of at least two capacitor branches; and
said at least two capacitor branches including a capacitor in series with an inductor and a capacitor branch switch.

11. The DC voltage circuit breaker according to claim 10, wherein said capacitors of said at least two capacitor branches have capacitances being different from each other.

12. The DC voltage circuit breaker according to claim 10, wherein said at least two capacitor branches are three to six capacitor branches.

13. The DC voltage circuit breaker according to claim 10, wherein one or a plurality of said capacitors are configured to produce a reverse current sufficient for switching nominal currents by closing a respective capacitor branch switch or switches.

14. The DC voltage circuit breaker according to claim 10, wherein one or a plurality of said capacitors are configured to produce a reverse current sufficient for switching short-circuit currents by closing a respective capacitor branch switch or switches.

15. The DC voltage circuit breaker according to claim 10, wherein one or a plurality of said capacitors are configured to produce a reverse current by closing a respective capacitor branch switch or switches for disconnecting a line when currents are very small.

16. The DC voltage circuit breaker according to claim 10, which further comprises an energy absorber connected in parallel with said commutator device.

17. The DC voltage circuit breaker according to claim 10, wherein said commutator device includes a series connection of a commutator resistor, a commutator coil and said capacitor circuit.

18. A method for operating a direct-current circuit breaker, the method comprising the following steps:
providing a direct-current circuit breaker including at least one interrupter and a commutator device connected in parallel with the at least one interrupter, the commutator device having a capacitor circuit, the capacitor circuit including a parallel connection of at least two capacitor branches, and the at least two capacitor branches including a capacitor in series with an inductor and a capacitor branch switch; and
ascertaining an opening condition for the direct-current voltage circuit breaker, the opening condition including at least one of the following opening conditions:
request for disconnecting capacitive loads and switching lines or cables,
request for opening under current flow,
increase of a current as an indicator of a short circuit,
exceeding a current increase rate over a limit value,
opening the at least one interrupter,
ascertaining at least one capacitor branch suitable for the opening condition, or
closing the capacitor branch switch or switches of the at least one ascertained capacitor branch.
